(19) United States
(12) Patent Application Publication
(10) Pub. No.: US 2015/0211701 A1
(43) Pub. Date: Jul. 30, 2015

(54) LED And/Or Laser Light Has More Than One Optics Means to Create Wider or Big Areas Image

(71) Applicant: Tseng-Lu Chien, Walnut, CA (US)

(72) Inventor: Tseng-Lu Chien, Walnut, CA (US)

(21) Appl. No.: 14/503,647

(22) Filed: Oct. 1, 2014

Related U.S. Application Data
(63) Continuation-in-part of application No. 14/023,889, filed on Sep. 11, 2013.

(51) Int. Cl. F21S 10/02; F21V 5/00; F21V 7/00; F21S 8/00; F21K 99/00

(52) U.S. Cl. CPC F21S 10/02; F21S 8/035; F21K 9/50; F21V 7/00; F21V 5/00; F21Y 2101/02

(57) ABSTRACT

An LED or/and Laser-light for outlet plug-in power source, or interchangeable power source or USB-means power source, incorporates more than one of geometric shape optics means(es) which any one of optics means may has more than one reflective or refractive means(es) which has relative positions, distances, and/or orientations to LEDs or/and Laser-light to let plurality of light beams reflect or retro-reflective or refractive by more than one reflector or refractor means(s), so the light beam(s) of the said LED(s) or laser-light(s) will reflective or/and refractive travel or pass though the said more than one optics means(es) to create or project image, message, time, geometric art, nature scene, galaxy, milky way, sky, cloud, stars, moon, water-wave, aurora light, animal, characters, cartoon, sign, logo, commercial to surface(s) surrounding including ceiling, walls, floor and all desire areas with wider view angle image. At least one of the optics means has see-though and reflective or refraction surface(s) to permit the plurality of LED(s) or laser-light(s) light beam(s) traveling or passing through the optics means. The said each of the said Optics means has its pre-determined texture, shaped opening, windows, cutout, variable thickness incorporate with motor/movement/spin/rotating/moving parts and accessories to make all kind of optics means become moving optics means to make said above wide viewing angle image become motion/moving/variable/changing color or patterns.

### BACKGROUND OF THE INVENTION

From market place, there has a lot of Desk Top Bulky device which has some optics means has motor noisy means to get some image to the walls or ceiling. All those items is not compact size with light weight and economic cost.

(Feature 1) The current invention mainly to design improved LED(s) or/and Laser-light(s) device has desired image, message, time, geometric art, nature scene, galaxy, milky way, sky, cloud, stars, moon, water-wave, aurora light, animal, characters, cartoon, sign, logo, commercial to the desired surface though the said LED(s) or/and Laser-light device which has the compact size with light weight to allow people to plug-in installation to any outlets device including wall, extension cord, power strips, outlets device or use USB-means power source.

Because plug-in outlet or USB means can easily connect with the power source which Is not like the AC wired, Adaptor with wire, transformer with wire device which the wires are very difficult to handle to prevent people to fall down or damaged to get electric-shock. So the current invention do not prefer to use WIRED power source which will cause consumer fall down and also too risky for desk top installation so preferred for outlets plug-in or USB means but has no wired.

Also, the Plug-in outlet or USB means also has the unlimited power source which is not like market available models which use Battery Operated for Desk Top applications which need to change battery very often so can supply the enough electricity for plurality of LEDs or/and Laser-light(s) which may need over hundreds Mini-Amperage current to make the battery unit per hour.

So the current invention for Plug-in outlets or USB means make a big improvement than market available desk top with wire or battery units.

(Feature 2) The current invention use traditional skill to use motor or rotating or magnetic & magnetic-coil means, or cheap and silent clock movement to make the said moving effects (including moving optic-means or moving light source(s)),

The said moving optic-means incorporate the others optics-means to become more than one of the so can increase the LED(s) or/and Laser-Light(s) performance, effect, functions including color change, size change, Motions, moving images and all other light functions, performance available from market place and its all combinations. Some preferred embodiment below will discussed may has 3.4.5 . . . optics means to form splendid light show.

(Feature 3) Further more, the current invention may use alternative design to create the moving effects no need to use the motor, or rotating or magnetic & magnetic-coil means is other alternative important improvement for cost consideration. I.E. The current invention as above discussion for alternative design for the said LED or/and Laser-light has no any motor means to make the said changeable image, message, time, geometric art, nature scene, galaxy, milky way, sky, cloud, stars, moon, water waves, animal, characters, cartoon, sign, logo, commercial to been seen.

(Feature 4) The current invention big improvement to make all moving or motion effects are made by plurality of LEDs' sequential flashing, fade-in and fade-out, color changing, sequential, random, or other LED light performance, effects, performance, duration and use the each LED with time difference, duration, on-off duty, cycles to turn on and turn off on different time and location and orientation to make the viewing image . . . etc to looking like moving.

(Feature 5) More advanced improvement, the shaped image, message, time, geometric art, nature scene, galaxy, milky way, sky, cloud, stars, moon, water-wave, aurora light, animal, characters, cartoon, sign, logo, commercial can easily get from at least one or more than one of the optics means which has its preferred texture, opening, cutouts, holes, shape, so can incorporated steady LEDs or/and Laser-lights' beam with rotating or non-rotating means to make the desired moon, stars, or moving aurora effects.

(Feature 6)

The current invention are Continue Filing or Division filing for co-pending filing U.S. Ser. No. 14/023,889 (#ZZZ) filed Sep. 11, 2013 and its continue filing U.S. Ser. No. 14/323,318 (#ZZZ-I) filed on Jun. 26, 2014.

both are the Continue filing U.S. Pat. No. 7,455,444 (More than one LED light source), U.S. Pat. No. 7,632,004 (More than one optic means), U.S. Pat. No. 8,277,087 (More than one reflective means to create multiple visible image). This also are CIP filing for U.S. Ser. No. 12/938,564 Laser project which filed on Nov. 2, 2014 still pending on US PTO.

The current invention are CIP of co-inventor's co-pending filing or following projection light device including:

U.S. Ser. No. 14/024,229 LED light has kaleidoscope means, Filed on 9-xxth-2013.
U.S. Ser. No. 13/021,124 LED light has changeable image and pattern by kaleidoscope means to project to surfaces. Filed on Feb. 4, 2011 and public on Aug. 9, 2012, 2012-0200-828.
U.S. Ser. No. 12/710,918 LED light has more than one reflector means, Now U.S. Pat. No. 8,8277,087 which similar with current invention to apply the kaleidoscope means which has more than one reflective means hereof use mirror or mirror-like means to assembly into kaleidoscope means.

U.S. Ser. No. 11/806,284 LED light has more than one optic means, now U.S. Pat. No. 7,632,004 which has use more than one optics means which similar with current invention to apply the optics means in front of or back of back of kaleidoscope means to create, adjust, magnify, reduce, enlarge the said the said image, LEDs light beams, LED lights' image, shape which including the any combination from optics lens, optics mirror, laser hologram, laser grating film, optics assembli

[symbol]

U.S. Pat. No. 7,455,444 LED light has more than one LED light source, the current invention use more than one LEDs for matrix arrangements with Circuit means, IC means, sensor means, switch means, brightness control means, color mix means, color selection means, color freeze means, motor means, gear means, turn-On and turn-Off means to make the certain number of LEDs turn-On with desired color, brightness, light brightness output, light functions, matrix combinations, motor means, rotating means, gear set means to pass though the said kaleidoscope means, optics means, laser mans, motor means, gear means, to has desired light patterns.

U.S. Ser. No. 12/948,953, U.S. Ser. No. 12/938,564 U.S. Ser. No. 12/886,832, U.S. Ser. No. 12/876,507, U.S. Ser. No. 12/771,003, U.S. Ser. No. 12/624,621, U.S. Ser. No. 12/914,584, U.S. Ser. No. 12/318,471, U.S. Ser. No. 12/318,470, U.S. Ser. No. 12/834,435 and also is continuous filing for co-inventor's prior filing cases as below issued patents:

U.S. Ser. No. 12/292,153 (now is U.S. Pat. No. 7,871,192),
U.S. Ser. No. 12/232,505 (now is U.S. Pat. No. 7,832,917),
U.S. Ser. No. 12/318,473 (now is U.S. Pat. No. 7,832,918). LED light has laser means
U.S. Ser. No. 12/624,621 (Now is U.S. Pat. No. 8,303,150) LED project light for Seasonal items
U.S. Ser. No. 12/771,003 (now is U.S. Pat. No. 8,408,736) Light device has More than one project means.
U.S. Ser. No. 12/876,507 (now U.S. Pat. No. 8,083,377) Light device has projection function with focus adjustable and project means can change position
U.S. Ser. No. 12/886,832 Digital data projection Light device, Sep. 8, 2010 filed
U.S. Ser. No. 12/938,564 Laser projection light device, Nov. 4, 2010 filed
U.S. Ser. No. 12/948,953 LED light has time projection. Nov. 13, 2010 filed.
U.S. Ser. No. 13/021,107 LED light has 3Dimensional projection, Feb. 4, 2011 filed.

Above listed Projection light device total has (9) projection light device are parent filing cases as CIP filing of the current invention.

Further more the Co-invention also has co-pending filing for light device has interchangeable power source for Wall outlets AC power and Energy storage means (Direct current) including the all kind of combination selection from prong mean, extension cord, adaptor, transformer, Solar, wind power, Batteries, chemical power, biologic power all can be interchange or for for any AC or battery power for Desk Top and Plug In type of current invention of project light device has build-in kaleidoscope means. The interchangeable co-filing cases as below:

U.S. Ser. No. 12/318,473,
U.S. Ser. No. 12/940,255 (Now U.S. Pat. No. 8,231,246) #FF-1

So the current invention are CIP for variety of co-inventor's co-pending or co-patents as above listed including: (1) Project light device (2) More than 1 optics means (3) More than 1 LEDs (4) More than 1 reflective means (5) Interchangeable power source (6) Laser Means (7) Adjustable focus and position changeable (8) motor & Gear set for moving adjustable.

This application has subject matter in common with U.S. patent application Ser. Nos. 12/710,561; 12/711,456; 12/771,003; 12/624,621; 12/622,100; 12/318,471; 12/318,470; 12/318,473; 12/292,153; 12/232,505; 12/232,035; 12/149,963; 12/149,964; 12/073,095; 12/073,889; 12/007,076; 12/003,691; 12/003,809; 11/806,711; 11/806,285; 11/806,284; 11/566,322; 11/527,628; 11/527,629; 11/498,874; 12/545,992; 12/806,711; 12/806,285; 12/806,284; 12/566,322; 12/527,628; 12/527,629; 12/527,631; 12/502,661; 11/498,881; 11/255,981; 11/184,771; 11/152,063; 11/094,215; 11/092,742; 11/092,741; 11/094,156. 11/094,155. 10/954,189; 10/902,123, 10/883,719; 10/883,747; 10/341,519; 12/545,992; and 12/292,580.

In particular, the following applications show light devices that have at least some features in common with included or optional features of the LED light device of the present invention: Ser. No. 12/710,561 (“LED power failure Light”); Ser. No. 12/711,456 (“LED light device has special effects”); Ser. No. 12/771,003 (“LED light device has more than 1 reflective means for plurality of image”); Ser. No. 12/624,621 (“projection device or assembly for variety of LED light”); Ser. No. 12/622,000 (“Interchangeable Universal Kits for all LED light”); Ser. No. 12/318,471 (“LED night light with pinhole imaging”); Ser. No. 12/318,470 (“LED night light with Projection features”); Ser. No. 12/318,473 (“LED night light with laser or hologram element”); Ser. No. 12/292,153 (“LED night light with Projection or imaging features”); Ser. No. 12/232,505 (“LED night light with Projection features”); Ser. No. 12/149,963 (“Removable LED light device”); Ser. No. 12/149,964 (“Surface Mounted Device with LED light”); Ser. No. 12/073,095 (“LED Track light device”); Ser. No. 12/073,889 (“LED light with changeable position with Preferable power source”); Ser. No. 12/007,076 (“LED light with changeable geometric system”); Ser. No. 12/003,691 (“LED light with changeable geometric dimension features”); Ser. No. 12/003,809 (“LED light with changeable features”); Ser. No. 11/806,711 (“Multiple LED light with adjustable angle features”); Ser. No. 11/806,285 (“LED Night light with outlet device”); Ser. No. 11/806,284 (“LED Night light with more than 1 optics means”); Ser. No. 11/527,628 (“Multiple function Night light with air freshener”); Ser. No. 11/527,629 (“LED Night light with interchangeable display unit”); Ser. No. 11/498,874 (“Area illumination Night light”); Ser. No. 11/527,631 (“LED Time piece night light”); Ser. No. 12/545,992 (“LED time piece Night light”); Ser. No. 12/292,580 (“LED Time Piece Night light”); Ser. No. 11/498,881 (“Poly Night light”); Ser. No. 11/255,981 (“Multiple light source Night Light”); Ser. No. 11/184,771 (“Light Device with EL elements”); Ser. No. 11/152,063 (“Outlet adaptor with EL”); Ser. No. 11/094,215 (“LED night light with liquid medium”); Ser. No. 11/094,215 (“LED Night light with Liquid optics medium”); Ser. No. 11/092,741 (“Night light with fiber optics”); Ser. No. 10/883,747 (“Fiber Optic light kits for footwear”); Ser. No. 11/498,874 (“Area Illumination for LED night light”); Ser. No. 11/527,629 (“Time Piece with LED night light”); Ser. No. 11/527,628 (“Multiple Function Night light with Air Freshener”); Ser. No. 11/806,284 (“LED Night light with more than one optics mediums”); Ser. No. 11/806,285 (“LED Night Light with multiple function”); and Ser. No. 11/806,711 (“Multiple LEDs Light with adjustable angle function”).

A preferred embodiment of the current invention includes an LED(s) or Laser-light(s) light has more than one optics means and each of optics means has passing though or reflective or/and refractive means within the geometric shape of the said optics means that provide a plurality of LED(s) or Laser-light(s) light beams to passing through or reflecting or/and refracting within the more than one reflector or/and refractive means inside the optics means.

The LED(s) or/and laser-light(s) device including at least one LED(s) or/and laser-light(s) arranged on the inner of the geometric optics means has more than one of the said reflective or/and refractive means, at least one of second reflective or/and refractive means within the geometric optics means which can reflect or refract LED(s) or/and Laser-light(s) light beam from its surface to 1^{st} or others reflective or refractive means surface(s) back and forth so some light beams been reflected or refracted and travel within the optics means and other some light beam are passing though the partial transparency optics means to outside.

In some preferred embodiments, a plurality of the light beam out of the said LED(s) or/and laser-light9s) can be traveling or passing though the said outside wider opening and wide viewing angle cover though the said surface(s). Furthermore, at least one of the reflective or/and refractive means may be partially transparent so that the plurality of light beam is passing though from the said surface(s) thereof. The other Plurality of the light beam is been reflected or retro-reflected or refracted within the other reflector and refractive means and passing though some other location of the said preferred of the said surface(s).

The LEDs or/and Laser-light(s) of these embodiment are preferably connected with circuit means, power means, contact means, conductive means, switch means, sensor means, motor means, movement means, magnetic unit & coil means, spin means, rotating means, gear set means, speed control means, printed circuit means, integrated circuit (I.C.) means and/or related parts and accessories to cause the LEDs or/and laser-light(s) to turn on and off according to a predetermined time period, functions, colors, and/or effects to provide a desired lighting performance.

In the above-described preferred embodiment, the reflective or/and refractive means may be a mirror-like polished surface, Optics lens, convex lens, concave lens, optics properties lens, chrome finished piece, polished piece, double-side mirror, or any surface in desired size, shape, thickness, focus, wide viewing angle which having reflective or refractive properties and let light beam can traveling or passing though both or more than one of the said optics means suitable to the current invention.

The partial transparent or see-though properties and reflective or refractive features can be provided by a transparent piece, colored transparent piece, or any other piece that allows light beams to pass there through or reflected or refracted. A power source of those embodiment can be in the form of an outlet, batteries, solar power, chemical power, or wind power by proper connect means at least for prong or USB means.

The LEDs or/and laser-light(s) can be selected from any combination of single color, multiple color, multiple piece, standard, and special assemblies, LED and Laser-Light number from 1 to N (N can be any number) to arrange in desire matrix, order, combination with proper spacing which available on the market.

Finally, the distance, position, orientation of the reflective or refractive means may be changed basing on the selected geometric shape of optics means v.s. the LED(s) or laser-light(s). The LEDs or Laser-Light(s) arrangement for different of LED or Laser-light number, position, color, IC chip, control means, circuit means, functions, and brightness and may selected to incorporate with the said motor/movement/spin/rotating/magnetic unit & coil means can create a desire plurality of light patterns, show, color changing, images changing, moving effects to people to be seen on surrounding surface(s) including walls, ceiling, floor, or desire surface(s).

The said geometric optics means can has any shape with multiple construction and the said the geometric optics means has desire combination selected from the passing though lens, reflective lens, convex lens, concave lens, laser lens, hologram lens, desired focus, thickness, variable thickness, plurality of optics means, wave texture, desired texture, curvature, curve, optics properties on the inner or outside surface or all sides of the surface to make certain light effects.

As noted above, the current invention uses more than one of geometric shape optics-means has built-in more than one reflective or refraction means to create a plurality of LED light or/and laserlight(s) light beam passing though, reflect, retro-reflect, refracted by the more than one of optics means and may selected to incorporated other electric parts & accessories to get wider viewing angle image . . . etc. The relative distance, position, and/or orientation of the more than one optics means v.s. Light source (and optional additional) reflective or/and refractive means will result in different light beam performance. This is a very low cost and simple way to make a splendid and eye catching light performance unit with wider viewing angle to cover wide area image . . . etc. for people and incorporated with any desired power source such as a battery, USB power, outlet power, generator power, chemical power, solar power, wind power or other equivalent power source from the marketplace.

### BRIEF DESCRIPTION OF THE DRAWINGS

FIG. 1 and FIG. 1A and FIG. 1B: shows 3 preferred embodiment of the current invention has prong means and more than one optic means to create wide viewing angle image. All of these embodiments has common parts including (1) Light source-LEDs or Laser-light(s) (2) Wider angle top cover with its preferred optic properties (3) More than one of optics means including inner 1^{st} one or inner more optics means each may has plenty of the reflective or refractive means build-in (4) Each optics means has predetermined optics properties by making the optics means has different size, shape, thickness, variable thickness, height, assortment, arrangement, combination and the geometric optics-means or has plenty of the convex-lens or concave lens build in one optic means all fall within the current invention scope. (5) the optics means or light source (LEDs or/and laser-light) may incorporate with motor/spin/rotating/motion/magnetic unit & coil means to make the optical means or light source to become moving optical means or moving light source to make the splendid light performance to has changeable image, message, time, geometric art, nature scene, galaxy, milky way, sky, cloud, stars, moon, water waves, animal, characters, cartoon, sign, logo, commercial to been seen.

FIG. 2 and FIG. 2A shows 2 preferred embodiment of the current invention's optic means has (1) Plenty of different lens build in on one piece, the plenty of optics unit which has different size, shape, geometric shape, thickness, focus, reflective properties, refractive properties to make the LED(s) or Laser-light(s) light source light beam can traveling or passing to make the splendid and pre-designed light beam pattern, color, spread out, shape, brightness, and other light effects, performance, functions available from market place and may incorporate with motor/movement/spin/rotating/magnetic unit & coil means to make the said optic means become moving optics means. From FIG. 2A shows the more than one optics means on the top of light source (LEDs and Laser-lights) the both light source light beam hit the center crystal-like optics ball, some light traveling and passing though the crystal-like optics ball basing on reflective or refraction theory so can created the very eye-catching light effects. The Both of optics means can cooperate with motor/moving/spin/rotating/magnetic unit & coil means to make optics means for moving optics means and moving reflective lens to get the desired light effects.

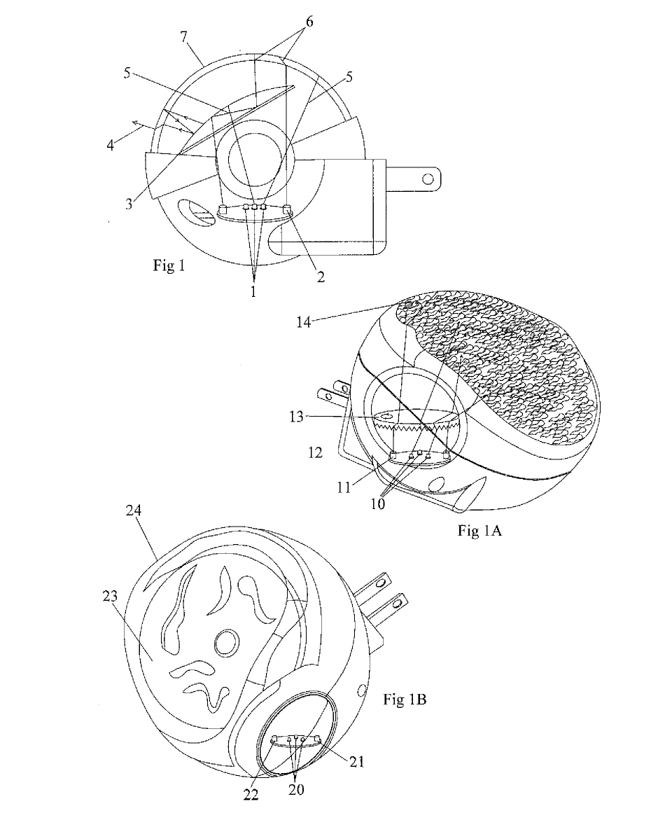

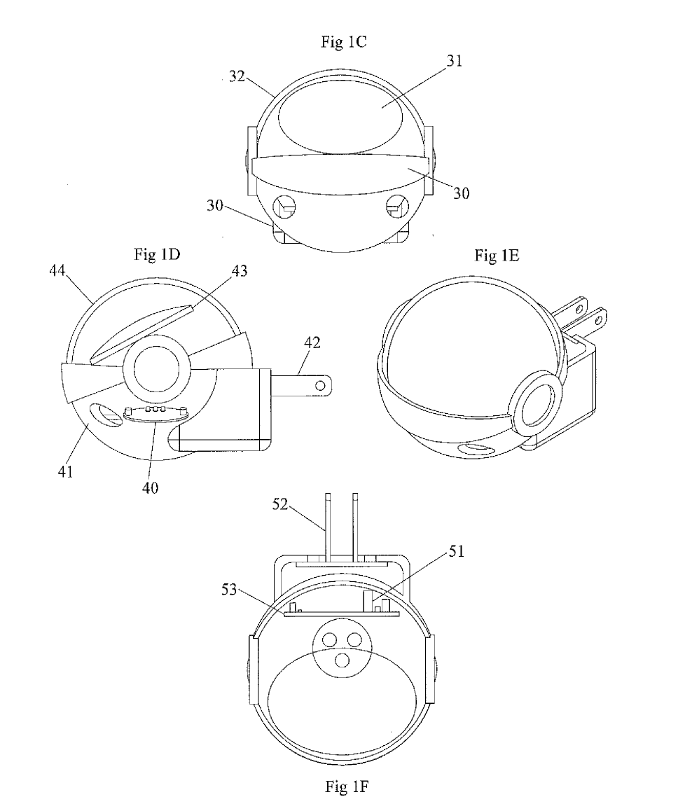

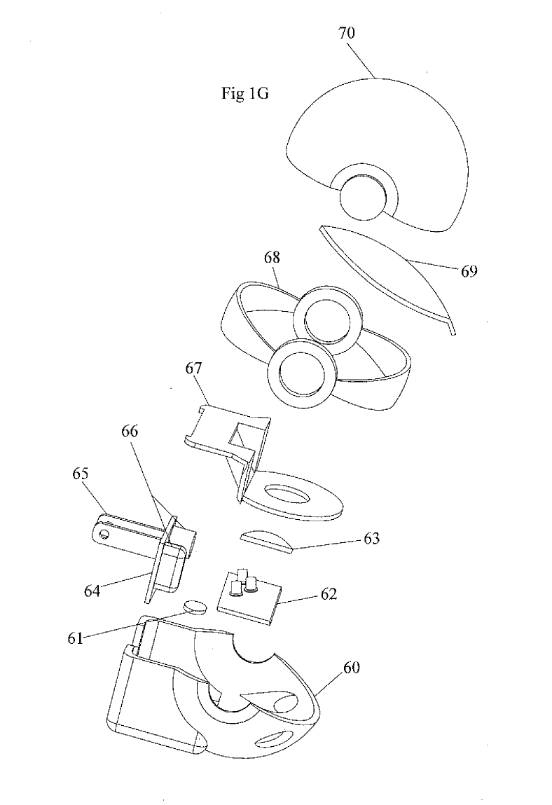

FIG. 1C and FIG. 1D and FIG. 1E and FIG. 1F: shows a first preferred embodiment of the current invention has (2) Optics means one is top cover and one is inner disc-like convex lens both has the preferred wave-textures has variable thickness so the LEDs or Laser-Lights some of the light beam can passing though the disc-like convex lens wave textures then has 1^{st} image and all these 1^{st} group image will traveling or passing the 2^{nd} Big and Wide optics-means to create the Super large size viewing angle image, message, time, geometric art, nature scene, galaxy, milky way, sky, cloud, stars, moon, water waves, animal, characters, cartoon, sign, logo, commercial to been seen.

FIG. 1G shows the First embodiments details construction.

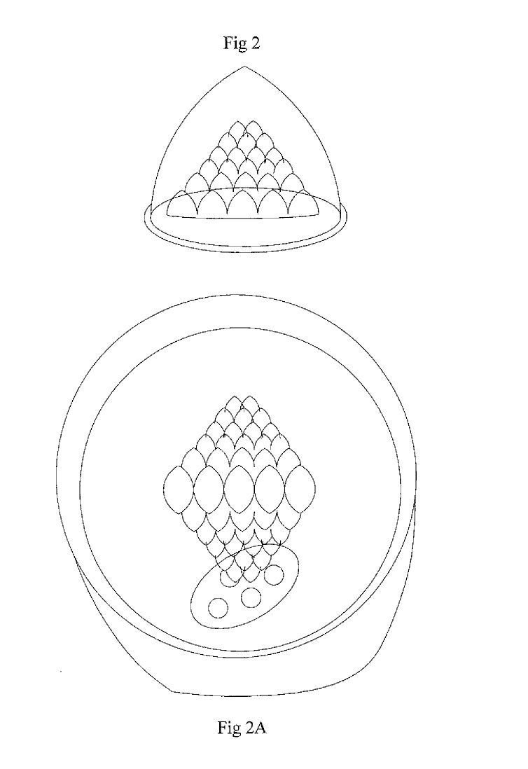

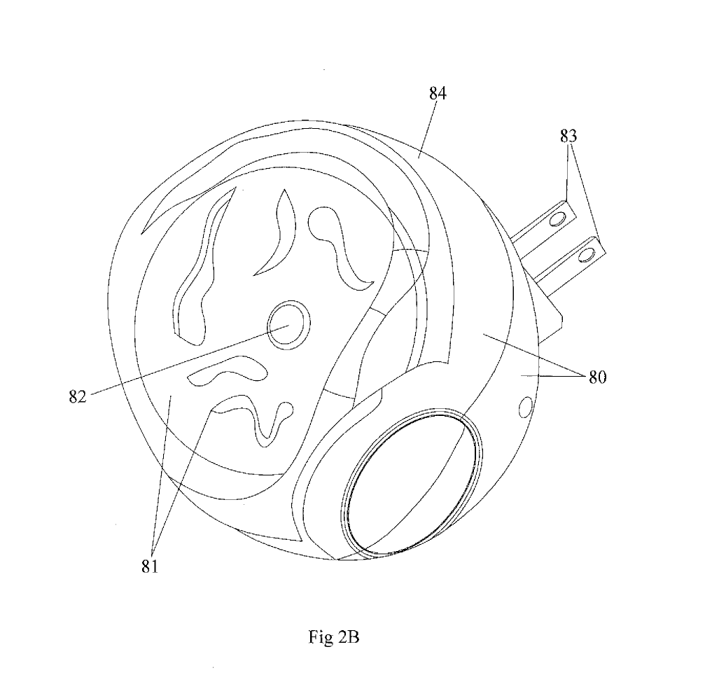

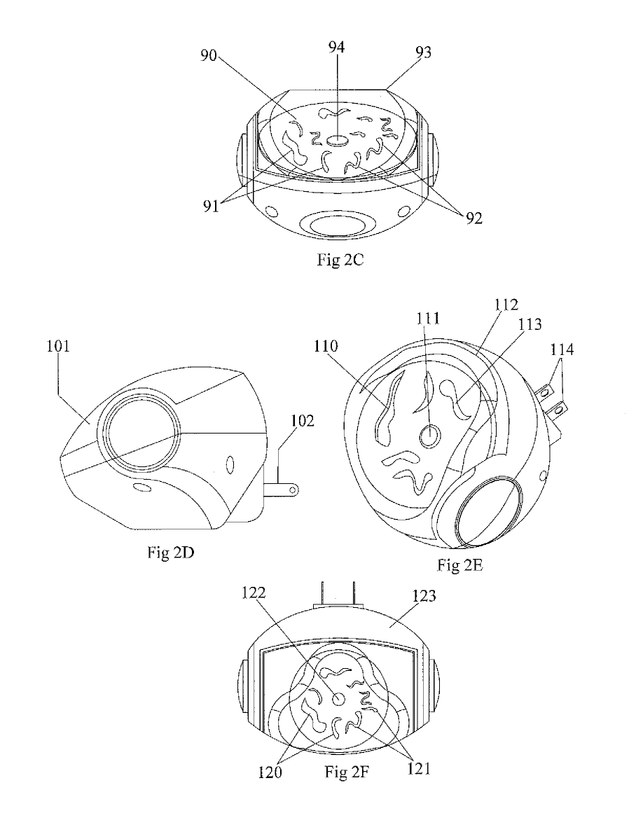

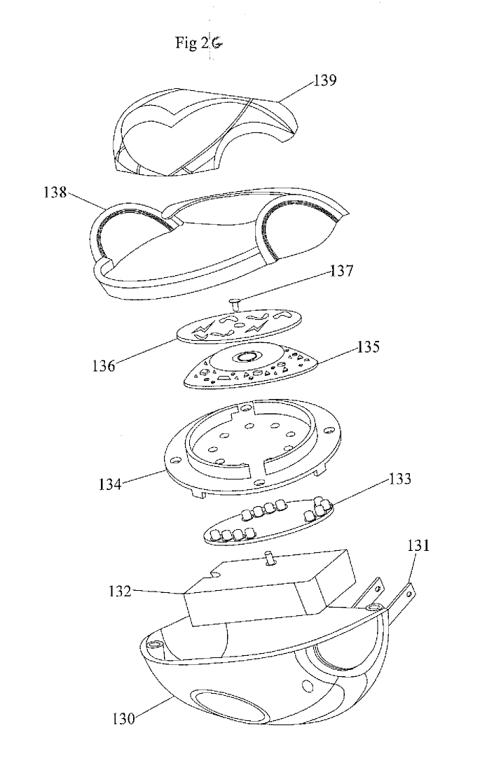

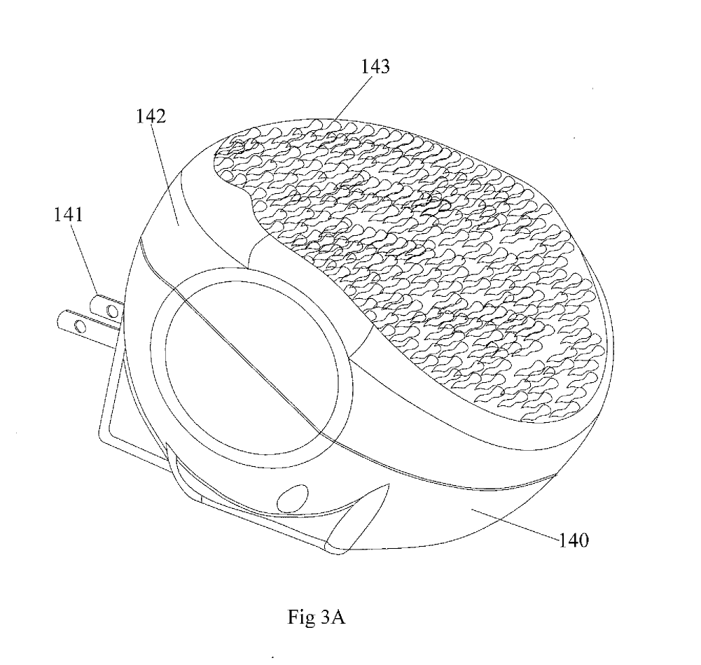

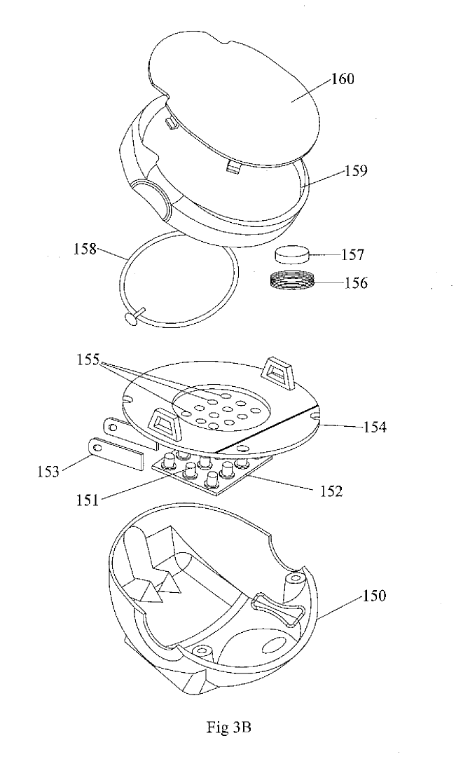

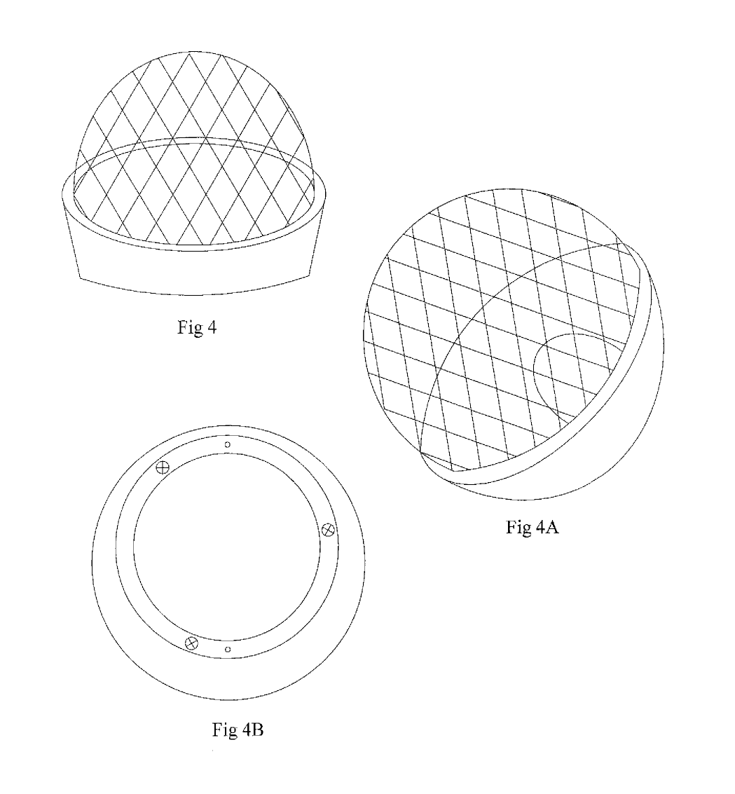

FIG. 2, 2A 2B and FIG. 2C and FIG. 2D and FIG. 2E and FIG. 2F shows the Second preferred embodiment which same as FIG. 1A for moving optics means or moving light source means which the said optics means has shaped openings, cutouts, holes, stencils, windows to allow the LEDs or/and Laser-light beam passing though the light-bock means' holes/opening/cutouts/stencils/windows and passing though the top Wide angle view angle cover which has its preferred optics textures, thickness, convex or concave lens properties, reflective or refraction optics properties to has image, message, time, geometric art, nature scene, galaxy, milky way, sky, cloud, stars, moon, water waves, animal, characters, cartoon, sign, logo, commercial to been seen. The second embodiment also may incorporate with motor/movement/spin/rotating/moving/magnetic unit & coil means to make the optics means or light source become moving type to make the motion light effects. This will increase more value for the said current invention.

FIG. 2G shows the second embodiment details construction.

From FIG. 3A shows the Third preferred embodiment again has more than one of optics means including top Wide viewing angle Optic-means cover which preferred has wave-like textures with variety of the thickness so has variable focus while the LEDs or/and laser-lights light beam hit the cover's some light beam will reflective and some light beam will refractive to viewer. The inner also has the 2^{nd} optics means which may is a moving optic-means connect with motor or magnetic unit & coil means to make shaving, waving, moving, motion of the said moving optic-means so the light beam traveling or passing though the inner moving optics means will make the LEDs or/and Laser-lights' light beam become changeable position, direction, orientation and hit the top cover's optic designs to come out more splendid light effects may be in any combination select from image, message, time, geometric art, nature scene, galaxy, milky way, sky, cloud, stars, moon, water waves, animal, characters, cartoon, sign, logo, commercial to been seen.

From FIG. 3B shows the Third embodiment details construction.

FIG. 4, 4A and FIG. 4B show the co-pending drawing for alternative design of Top cover optic means has plurality of reflective and refractive optics lens design so can make light source light beams to back and forth within the Top Cover in ball shape to make the light source light beam to spread out to get the image for wide range, big size but this also can apply and fall within the current scope of the invention.

### DETAILED DESCRIPTION OF THE PREFERRED EMBODIMENTS

From FIG. 1 and FIG. 1A and FIG. 1B, The LED or laser-light device has more than one optic-means has reflective or refractive means for the Plug-In type has the prong means to connect with outlets from wall, extension cord, power stating, desk lamp outlets receptacles.

The LED or laser-light device create the light image to ceiling, walls, floor from the more than one optics-means construction and has top cover which has wide and big size so can let the all light beams from light source can be spread out to wider and bigger space, area, locations.

The optics-means has more than one optics lens has convex or reflective or refractive or any combination of these optics properties's construction basing on the requirement. Hence, the current invention any light beam can traveling or passing though at least more than one geometric shape optics-means and the said light beam emit out from LED or laser-lights' head to hit the 1^{st} reflective or refractive-means, then, Hit 2^{nd}, 3^{rd}, 4^{th} . . . . Till the light beam are pass though to outside though the top optics cover means.

From FIG. 1 show the more than one of optics means including the Top cover 7 and inner optics means 3. The Top cover 7 has textures or variety reflective or/and refractive lens design to make all incoming light beam to reflective or/and refracted traveling or passing though the top cover to viewer. The light beam 5 or 6 emit from the below LEDs 1 or Laser-Light(s) 2 to get the very splendid color, light sport, diffusion, variable pattern while incorporated with the said IC or movement means, motion means to make the light effects to view.

From FIG. 1-A shown the more than one of optics means 13 and 14 Not Only including the Top Cover with textures here prefer as wave textures, inner 2^{nd} optics means 13 which is movable, shakable, waving, rotating, spin so can make the non-movable Light source including LEDs 10 or/and Laser-lights 11 light beam passing though the movable 2^{nd} optics means 13 and its optics designs such as textures or plurality of wave shaped optics lens under multiple times of reflection or/and refraction so get the top cover optics means for input light beam.

The input light beam hit the 1^{st} top cover optics means 14 and its texture or optics designs will make multiple times reflection or/and refraction can make the light performance become motion waves effects or such as Aurora, moving clouds, changeable galaxy, moving stars, moving milky river or other nature scene can be produce under details design.

From FIG. 1B show the moving optics as 2^{nd} optics means 23 which incorporated under 3^{rd} optics means 25 which has plurality of tiny optics lens which has different size, shape, geometric shape, thickness, focus, colors and may incorporate with motor means, spin means, rotating means, movement, magnetic unit & coil means, shaking means, waving means, crane means to make the fixed LEDs 20 or Laser-lights' 21,22 light beam travel and passing though the lower 3^{rd} optical means 25 hit to 2^{nd} moving optics 23 has shaped holes, windows, cutouts, opening means and light can be shaped to certain range such as aurora light shape, cloud shape, star shape, milky river, galaxy shape, then the light beam will hit to the 1^{st} cover optic means 24 to enlarge light beam to spread out to wider viewing angle image to let viewers to see.

These (3) detail drawing show all the light beam emit out from the lower position's LEDs or Laser-Light(s) Traveling or/and passing though different 2^{nd} or 3^{rd} optic means to make some plurality of light beams or shaped light beams and hit the cover optics means which are very good design and can not make by single Optics means to get such effects.

The current invention show the some optics means including
(1) Optic means has textures
(2) Optics means has shape holes, opening, cutouts, window, stencil
(3) Optics means is moving optic means while incorporate with crane means, motor means, spin means, rotating means, movement means, Magnetic unit & coil means.
(4) Optic means has plurality different shape, size, color, thickness, variable thickness in one piece to get fixed LEDs or Laser-light light beam to become very splendid and spread out light beam
(5) Optic means for Cover which has wide opening so can has wider viewing angle to make all light beams to spread out to wider and Bigger areas with said designed Image wanted
(6) Optics means can be any shape such as sheet, piece, ball, half ball, bar, cover or any Other geometric shape with its preferred optic construction including texture, opening, Window, convex lens, magnify lens, variable thickness, variable focus by plurality of tiny optic means, reflective means, refraction means has steady fixed or moving, waving, shaking, vibration, rotating added features.
   So these are the other features for the current invention from the above FIG. 1, FIG. 1A, FIG. 1B.

From FIG. 1 and FIG. 1A and FIG. 1B. The cover optics-means and inner 2^{nd} or 3^{rd} optics mans make the light beam came out from LED or/and laser-light create a splendid color image to all surrounding area because the current invention has construction of (s) the inner built-in more than one LEDs or/and laser-light(s). The LEDs or/and laser-light(s) may selected from group of color, specification, size, functions, power, watt, and each LED or/and laser-light(s) can has its emit direction, orientation, angle to anywhere because the inner has more than one reflect-means as inventor's prior patented claims so the each LED or/and laser-light(s) device has different light emit direction even LED or/and laser-light emit angle is narrow but after the light beam been under may reflected or/and refracted then, the light will come out all over the device and come out from the wider viewing angle top cover or desired sides . . . . This is the result basing (1) More than one LEDs or laser-light(s) (2) More than one Reflect or Refractive-means (3) more than one optics-means with desired optic properties (4) Selected incorporate with other parts & accessories may in desired combination selected from motor means, movement means, magnetic unit & coil means, Interchangeable power source, moving optics means, light-block means with shaped holes, opening, windows, texture lens, optics lens, plurality of optics lens, IC means, power source means . . . etc. which may use all inventor's co-pending prior arts scope as inventor's all prior patents and co-pending all LED project light concept as above and below listed (9) co-pending and issued Prior arts.

Ser. No. 12/318,471, U.S. Ser. No. 12/318,470, U.S. Ser. No. 12/834,435 and also is continuous filing for co-inventor's prior filing cases as below issued patents:
U.S. Ser. No. 12/292,153 (now is U.S. Pat. No. 7,871,192),
U.S. Ser. No. 12/232,505 (now is U.S. Pat. No. 7,832,917),
U.S. Ser. No. 12/318,473 (now is U.S. Pat. No. 7,832,918). LED light has laser means
U.S. Ser. No. 12/624,621 (Now is U.S. Pat. No. 8,303,150) LED project light for Seasonal items
U.S. Ser. No. 12/771,003 (now is U.S. Pat. No. 8,408,736) Light device has More than one project means.
U.S. Ser. No. 12/876,507 (now U.S. Pat. No. 8,083,377) Light device has projection function with focus adjustable and project means can change position
U.S. Ser. No. 12/886,832 Digital data projection Light device, Sep. 8, 2010 filed
U.S. Ser. No. 12/938,564 Laser projection light device, Nov. 4, 2010 filed
U.S. Ser. No. 12/948,953 LED light has time projection. Nov. 13, 2010 filed.
U.S. Ser. No. 13/021,107 LED light has 3Dimensional projection, Feb. 4, 2011 filed.

Above listed Projection light device total has (9) projection light device are parent filing cases as CIP filing of the current invention.

From FIG. 1C show the Alternative Current (AC) power units which has the AC adaptor, transformer, AC wires to connect with units to get make the LED project light to have splendid project light image to be seen.

From FIG. 1D and FIG. 2E Show the Direct Current (DC) power unit which can have power from any Direct current device such as batteries, energy storage means, solar power, wind power, chemical power.

It is appreciated for the Interchangeable power source as the inventor prior art as above listed patent U.S. Pat. No. 8,434,927.

From FIG. 2 and FIG. 2A show the (2) preferred optics means has plurality of different size, shape, thickness, focus, color optics lens in one piece to make the LEDs or Laser-lights' light beam traveling or passing though to hit the OTHERS more than one optic means optics means has desire optics properties may in group combination select from optics lens, convex lens, concave lens, reflective lens, refractive lens, moving optic means, Light-block means with holes, opening, windows, cutouts, stencils, or optic texture lens to make the light beam→1^{st} optic means→2^{nd} optics means (or to N optics means) to create the splendid light performance, effects, functions.

From FIG. 2A, It also appreciated that the more than one optics means and LEDs or/and Laser-lights has also incorporated with other electric parts & accessories may in group combination selected from power source, circuit means, motor means, Movement means, spin means, rotating means, magnetic unit & coin means, IC means, sensor means, control means, conductive means, prong mean, USB means, circuit means, and all other electric parts & accessories so can have right and pre-determined light function.

FIG. 1C, FIG. 1D, FIG. 1E, FIG. 1F shown the 1^{st} preferable embodiment major parts details.
(Details shown aside the Figure)

FIG. 1G show the 1^{st} preferable embodiment all major parts construction.
(Details shown aside the Figure)

FIG. 2B, FIG. 2C, FIG. 2D, FIG. 2E, FIG. 2F shown the 2nd preferable embodiment major parts details. (Details shown aside the Figure)

FIG. 2G show the 2nd preferable embodiment all major parts construction.
(Details shown aside the Figure)

FIG. 3A shown the 3rd preferable embodiment major parts details.
(Details shown aside the Figure)

FIG. 3B show the 3rd preferable embodiment all major parts construction.
(Details shown aside the Figure)

From FIG. 1 and FIG. 1A and FIG. 1B show the Plug-In type light device with base are install on the Plug-In housing to make the Alternative Current (A.C.) to drive the inner circuit means, LEDs or/and laser light, Sensor means, switch means, control means, and optional motor means to make the moving optics means so can make motion effects of the related image to ceiling/walls/floor has plenty of color and moving (If add the motor means).

The Said geometric shape optics-means has more than one reflect or refract means for the current FIG. 1 and FIG. 1A and FIG. 1B for all the said optis means of the said preferred LED or laser light device devices which preferred has the sphere or ball top cover optics-means has plurality of optics lens with desired optics properties including magnify and diffusion or spread out the light beams by may has mirror-polished reflect or refraction means for outside or inside and has round convex surface outside of each optics means so it become a convex-lens. Not only can reflect the light beams also can allow light beam refraction and pass though to wider areas so the Big Cover optics means is needed for current invention.

It is appreciated that the non-shown details for the Alternative Current (A.C.) type power unit has receptacle to receiving transformer, adaptor or AC wires. Adaptor or AC wires to drive the circuit, to make the light source(s) turn on and emit light beam to desire area(s). It also can use USB wire to get power from the USB Ports. These common skill can use from market place.

From FIG. 1 and FIG. 1A and FIG. 1B shows light device its optic means has more than one reflective or refraction on its surface within one optics-means to allow light beam can traveling or pass though the convex-lens especially for the TOP Cover Optics means and reflect within the reflective-lens or refraction to let light emit out to create image on ceiling, walls, floor.

From FIG. 2F Show the inner construction for one of preferred the light device has built-in motor means 132 (or equivalent motor means as above listed all replaceable means) to fix the motor means on the housing may by screw means. It also show the motor means has work with gear-set means (not shown inside motor means box) to reduce the motor's rotating speed to slower speed to prevent from people uncomfortable to see quickly moving image on ceiling, walls, floor. It also not show the switch means, electric parts & accessories, conductive wires to connect with circuit means and the get the power source constructions.

From co-pending filing, the alternative design for top cover with convex lens features also still fall within the current invention scope as (#ZZZ) (#ZZZ-I) (#ZZZ-II) FIG. 4 also Show the Light beam reflect within the more than one reflect-means which on inner of the optics-means which are in the shape of sphere. Also, the light beam pass though the outside convenx-lens to project the image to the ceiling, walls, floor. This embodiment teach (1) more than one reflect-means in optics-means (2) light project though the more than one optics-means which the inner side is a flat mirror-polished reflector and outside is convex-shape so it is a convex-lens (3) each convex lens get together to form a semi-sphere geometric shape. (4) 2 half-sphere ball.

From co-pending filing, the alternative design for top cover with convex lens features also still fall within the current invention scope as (#ZZZ) (#ZZZ-I) (#ZZZ-II) FIG. 4A: Show the other viewing angle for the 2 half-shaped sphere with base to form the optics-means which has more than one optics-means. The each one of the optic-means has more than one reflect-means to form the half-sphere geometric ball. This is same concept with inventor's earlier U.S. Pat. No. 7,632,004 LED night light has more than one optics means. U.S. Pat. No. 8,277,087 has more than one reflect means. U.S. Pat. No. 7,455,444 LED night light has more than one LED. U.S. Pat. No. 8,434,927 interchange power source for current invention scope.

From co-pending filing, the alternative design for top cover with convex lens features also still fall within the current invention scope as (#ZZZ) (#ZZZ-I) (#ZZZ-II) From FIG. 4B: Show the inner side of the 2 shape optical-means which has more than one reflect-means inside of the each of optics-means so can overcome LED's narrow light beam angle. The current invention all LEDs has different direction to emit the light beam to reflect-means even the light angle is narrow it is not a problem because the light emit from LED head will hit the 1st reflect-means, then hit to 2nd, 3rd, 4th . . . reflect-means till the light beam been 100% pass though convex-lens so this is current features too! Add motor can make the image be rotating to get moving image to viewer. The construction.

FIG. 4 and FIG. 4A and FIG. 4B show the co-pending drawing for alternative design of Top cover optic means has plurality of reflective and refractive optics lens design so can make light source light beams to back and forth within the Top Cover in ball shape to make the light source light beam to spread out to get the image for wide range, big size but this also can apply and fall within the current scope of the invention.

In the preferred embodiments, images are created based on the relationship between the first optics means and the second optics means or all other optics means. The light device can employ any kind of design, shape, display, or geometric arrangement of the more than one optics means to create big size or large image to cover Big area for special light effects.

Although specific preferred embodiments of the current invention are described above, it is to be appreciated that all alternative, equivalent, same-function and/or same-skill-or-theory variations, modifications, replacements, arrangements, or constructions may still fall within the current scope of the invention.

1. An LED or/and Laser light device having more than one optics means to create Wider range image comprising:
at least one LED or/and Laser light units;
more than one of optics means has geometric shape and each has reflective or refractive properties and
The light beam emit from LEDs or/and Laser-light(s), Traveling or passing though the 1^{st} optics means and hit to others More than one optic-means to create a wider range or bigger size of image, message, time, geometric art, nature scene, galaxy, milky way, sky, cloud, stars, moon, water waves, aurora light, animal, characters, cartoon, sign, logo, commercial been viewing and project to surrounding surface(s) including ceiling, walls, other surfaces(es).
The LEDs or/and Laser lights can be selected from any combination of single color, multiple color, multiple piece, standard, and special LEDs or/and Laser lights assemblies, LED or laser lights number from 1 to N (N can be any number) to arrange in desire matrix, combination has the predesigned spacing or distance, position, orientation to get desired light effects which may select from available items from the market.
The LEDs or laser lights are preferably connected with parts & accessories in any combination from circuit means, power means, prong means, USB means, battery means, AC power means, contact means, conductive means, switch means, sensor means, stencil mean, light block material with opening, shape windows, cutouts, stencil treated, motor means, spin means, rotating means, magnetic-coil and magnetic means, gear set means, speed control means, printed circuit means, integrated circuit (I.C.) means and/or related parts and accessories to cause the LED or laser light to turn on and off according to a predetermined time period, functions, colors, and/or effects to provide a desired lighting performance.
wherein said at least one LED or/and laser light connected to a power source by conductors and circuitry including means for causing said at least one LED or/Laser light to turn on and off for a predetermined period to provide predetermined functions, colors, and effects.
The said LED or/and laser light device create or project image, message, time, geometric art, nature scene, galaxy, milky way, sky, cloud, stars, moon, water waves, aurora light, animal, characters, cartoon, sign, logo, commercial from light source(s) emit light beam traveling or passing though the more than one optics means which any one of optic means at least has one of reflect-means or refraction-means OR more than one optics-means to desired surface.
The improvement including:
Wherein, the said LED light is plug-in Outlets device or has USB means to connect with the power source not electric wired.

2. An LED or/and laser light device having more than one optics means to create Wider Viewing Angle image, message, time, geometric art, nature scene, galaxy, milky way, sky, cloud, stars, moon, water waves, aurora light, animal, characters, cartoon, sign, logo, commercial as recited in claim 1, wherein said reflective or refractive means is selected from the group consisting of a mirror, chrome-finished piece, fine-polished piece, and double-sided mirror, or optics lens on variety selections, light block material has shaped opening, cutouts, holes, windows, stencil, or any reflective or refractive optics means related parts and/or accessories to make light beams traveling, passing, or reflect, or refract by said these means to make the desired display with steady or moving effects as pre-determined effects, performance, functions.

3. An LED or/and laser light device having more than one optics means to create Wider Viewing Angle or range image, message, time, geometric art, nature scene, galaxy, milky way, sky, cloud, stars, moon, water waves, aurora light, animal, characters, cartoon, sign, logo, commercial as recited in claim 1, wherein said optics means may in group combination selected from
(1) Optic means has textures
(2) Optics means has shape holes, opening, cutouts, window, stencil
(3) Optics means is moving optic means while incorporate with crane means, motor means, spin means, rotating means, movement means, Magnetic unit & coil means.
(4) Optic means has plurality different shape, size, color, thickness, variable thickness in one piece to get fixed LEDs or Laser-light light beam to become very splendid and spread out light beam
(5) Optic means for Cover which has wide opening so can has wider viewing angle to make all light beams to spread out to wider and Bigger areas with said designed Image wanted
(6) Optics means can be any shape such as sheet, piece, ball, half ball, bar, cover or any Other geometric shape with its preferred optic construction including texture, opening, Window, convex lens, magnify lens, variable thickness, variable focus by plurality of tiny optic means, reflective means, refraction means has steady fixed or moving, waving, shaking, vibration, rotating added features.

4. An LED or/and laser light device having more than one optics means to create Wider Viewing Angle or range image, message, time, geometric art, nature scene, galaxy, milky way, sky, cloud, stars, moon, water waves, aurora light, animal, characters, cartoon, sign, logo, commercial as recited in claim 1, wherein said power source is selected from the group consisting of an outlet, batteries, solar power, chemical power, and wind power or market available energy to provide electricity though related circuit means to drive said at least one LED or LEDs or Laser Light(s) to emit light beams.

5. An LED or/and laser light device having more than one optics means has reflective and/or refract properties to create Wider Viewing Angle or range image, message, time, geometric art, nature scene, galaxy, milky way, sky, cloud, stars, moon, water waves, aurora light, animal, characters, cartoon, sign, logo, commercial as recited in claim 1, wherein additional motor means/spin means/movement means/motion means/magnetic unit & coil means, and gear set means fit within the LED or/and Laser light device to make or create or project the Moving image(s) message, time, geometric art, nature scene, galaxy, milky way, sky, cloud, stars, moon, water waves, animal, characters, cartoon, sign, logo, commercial has per-determined functions, effects, performance for wide range or space or area has these light effects to be seen.

6. An LED or/and laser light device having more than one optics means to create Wider Viewing Angle or range image, message, time, geometric art, nature scene, galaxy, milky way, sky, cloud, stars, moon, water waves, aurora light, animal, characters, cartoon, sign, logo, commercial as recited in claim 1, wherein said at least one LED or/and Laser Light selected from a single or multiple color, multiple pieces, a standard unit, and a custom made assembly, more than one light source, more than one colors, more than one wattage of Laser light output.

7. An LED or/and laser light device having more than one optics means to create Wider Viewing Angle or range image, message, time, geometric art, nature scene, galaxy, milky way, sky, cloud, stars, moon, water waves, aurora light, animal, characters, cartoon, sign, logo, commercial as recited in claim 1, wherein said the device models which has emit or projection light beams to more than one surface may in group combination selected from (1) plug-in Wall outlet, receptacles, extension cord, Power strip or cigarette light application or (2) USB means power device.

8. An LED or/and laser light device having more than one optics means to create Wider Viewing Angle or range image, message, time, geometric art, nature scene, galaxy, milky way, sky, cloud, stars, moon, water waves, aurora light, animal, characters, cartoon, sign, logo, commercial as recited in claim 1, wherein said the geometric optics means has desire combination selected from the passing though lens, reflective lens, refractive lens, convex lens, concave lens, laser lens, hologram lens with preferred texture, polish finish surface, thickness, curvature, plurality of different thickness, different focus, plurality of tiny optics means combination in one piece and the inner or outside surface or all sides of the optics means surface(s) has its own certain light effects.

9. An LED or/and laser light device having more than one optics means to create Wider Viewing Angle or range image comprising:
at least one LED or/and Laser Light;
at least one or more than one of optics means has geometric shape and the surface has at least one reflective or refractive means, optics-properties; and
The said reflective or refractive means having a reflecting or refractive surface for reflecting or refractive light from the said LED(s) or laser lights.
The said at least one or More than one optic-means has more than one of light beam traveling or passing though to create a wider range or bigger size of image, message, time, geometric art, nature scene, galaxy, milky way, sky, cloud, stars, moon, water waves, aurora light, animal, characters, cartoon, sign, logo, commercial been viewing and create or project to surrounding surface(s) including ceiling, walls, other surfaces(es) while install on desk-top or USB means or plug-into all kind of outlets or extension cords or connect with the power source by prong means, USB means, wire means, adaptor means, transformer means with or without wire.
The LEDs or laser lights can be selected from any combination of single color, multiple color, multiple piece, standard, and special light source assemblies, light source number from 1 to N (N can be any number) to arrange in desire matrix and arrangement has preferred spacing, distance, orientation for all light sources/
The LEDs or laser lights are preferably connected with parts & accessories in any combination from circuit means, power means, prong means, USB means, battery means, AC power means, contact means, conductive means, switch means, sensor means, motor means, spin means, rotating means, movement means, magnetic-coil and magnetic means, gear set means, speed control means, stencil mean, block material with opening, shape windows, cutouts, printed circuit means, integrated circuit (I.C.) means and/or related parts and accessories to cause the LEDs or Laser lights to turn on and off according to a predetermined time period, functions, colors, and/or effects to provide a desired lighting performance.
wherein said at least one LED or laser light are connected to a power source by conductors and circuitry including means for causing said at least one light sources to turn on and off for a predetermined period to provide predetermined functions, colors, and effects.
The said LED and laser light device create or project image, message, time, geometric art, nature scene, galaxy, milky way, sky, cloud, stars, moon, water waves, aurora light, animal, characters, cartoon, sign, logo, commercial from the said light source(s) emit light beam traveling or passing though the at least one or more than one optics means which optics means surface has at least has one of reflect-means or refraction-means OR both.
The improvement including:
Wherein, the said light device has no any motor means to make the said changeable image, message, time, geometric art, nature scene, galaxy, milky way, sky, cloud, stars, moon, water waves, aurora light, animal, characters, cartoon, sign, logo, commercial to been seen.
Wherein, the all moving effects are made by plurality of LEDs' sequential flashing, fade-in and fade-out, color changing, sequential, random, or other LED light performance, effects, performance, duration and use the each LED with time difference, duration, on-off duty, cycles to turn on and turn off on different time and location and orientation to make the viewing image . . . etc to looking like moving.

10. An LED or/and laser light device having more than one optics means to create Wider Viewing Angle or range or size of image comprising:
at least one LED or/and Laser light;
at least one or more than one of optics means has geometric shape has more than one reflective or refractive means, optics-properties; and
The said reflective or refractive means having a reflecting or refractive surface for reflecting or refractive light from the said LED or LEDs or laser lights.
The said at least one or More than one optic-means also has more than one of light beam traveling or passing though to create a wider range image, message, time, geometric art, nature scene, galaxy, milky way, sky, cloud, stars, moon, water waves, aurora light, animal, characters, cartoon, sign, logo, commercial been viewing and create or project to surrounding surface(s) including ceiling, walls, other surfaces(es) while install on plug-into all kind of outlets or extension cords or connect with the power source by prong means, USB means, wire means.
The LEDs and Laser Light can be selected from any combination of single color, multiple color, multiple piece, standard, and special light sources assemblies, light sources number from 1 to N (N can be any number) to arrange in desire matrix or arrangement has desired spacing, distance, position, orientation.
The LED or laser Light are preferably connected with parts & accessories in any combination from circuit means, power means, prong means, USB means, battery means, AC power means, contact means, conductive means, switch means, sensor means, motor means, spin means, rotating means, magnetic-coil and magnetic means, gear set means, speed control means, stencil mean, block material with shaped opening, windows, cutouts, holes, stencils, or printed circuit means, integrated circuit (I.C.) means and/or related parts and accessories to cause the LED or laser light or any combination light source to turn on and off according to a predetermined time period, functions, colors, and/or effects to provide a desired lighting performance.
wherein said at least one of light sources are connected to a power source by conductors and circuitry including means for causing said at least one of light source to turn on and off for a predetermined period time to provide predetermined functions, colors, and effects.
The improvement including:
The said LED or/and laser light create or project image, geometric art, nature scene, galaxy, milky way, sky, cloud, stars, moon, water waves, aurora light, animal, characters, cartoon, sign, logo, commercial from light source(s) emit light beam traveling or passing though the at least one or more than one moving optics means which light beams passing though the moving optic-means drive by motor means, or spin means, or rotating means, or magnetic & magnetic coil means, movement means or desired combinations.
Wherein, the said moving optics means made of light block-out material with shaped opening, cutouts, windows, stencil OR/ The moving optics means has its preferred optical texture or desired shape has variety or plurality of different thickness, wave texture, windows, opening, cutouts to allow light passing though so create desired changeable image, message, time, geometric art, nature scene, galaxy, milky way, sky, cloud, stars, moon, water waves, aurora light, animal, characters, cartoon, sign, logo, commercial to been seen.
The said device is Plug-in outlet device or USB means device can connect the power source by prong means or outlet connector means.
